(19) United States
(12) Patent Application Publication
(10) Pub. No.: US 2005/0056235 A1
(43) Pub. Date: Mar. 17, 2005

(54) Illumination device for pet collars and other pet accessories

(76) Inventor: Brian Tobia, Superior, CO (US)

Correspondence Address: Emery L. Tracy, P.O. Box 1518, Boulder, CO, 80306-1518, US

(21) Appl. No.: 10/887,171

(22) Filed: Jul. 7, 2004

Related U.S. Application Data
(60) Provisional application No. 60/485,782, filed on Jul. 9, 2003.

(51) Int. Cl. A01K 27/00

(52) U.S. Cl. 119/859

(57) ABSTRACT

An illumination device for collars and other accessories is provided. The illumination device comprises a tubular strap. A lighting mechanism having a light source is at least partially receivable within the tubular strap. A mechanism activates the lighting source within the mechanism wherein light from the light source is emitted through at least a portion of the tubular strap.

The present application is a continuation of pending provisional patent application Ser. No. 60/485,782, filed on Jul. 9, 2003, entitled “Illumination Device for Pet Collars and Other Pet Accessories”.

### BACKGROUND OF THE INVENTION

1. Field of the Invention

This invention relates generally to pet leashes, collars, and similar restraining devices and pet accessories and, more particularly, the invention relates to an illumination device for pet collars, pet leashes, and similar restraining devices which illuminates these items for fun and safety.

2. Description of the Prior Art

The act of walking a dog is a pleasure enjoyed by many pet owners. The ability to get outside and experience nature and the surroundings is a simple joy. There are also the great health benefits associated with exercise for both the dog and the human walker. However, many pet owners have jobs which limit their walking time to night time hours, or many pet owners just enjoy walking at night. While the health benefits are the same, there is an increased danger from not being seen by motorists or from not being able to see your pet while walking at night. While reflective clothing may help the owner, the pets being walked are still at risk. The risk increases greatly should the pet get away and run free. Additionally, there are some work dogs such as police dogs, rescue dogs and the like who work at night without the benefit of a nearby handler who would benefit from increased visibility.

Various types of pet accessories, such as collars and leashes, have been available for attaching identification to a pet animal or restraining the animal during a walk. It is known to attach devices such as reflectors and lights to pets to make them more visible in the dark, for the convenience of the owner as well as for the safety of the pet. One example is a light apparatus fastened to a pet's collar having a battery, connected to an electric lamp and a switch. The light apparatus moves freely on the collar, tending toward an orientation favored by gravity. A contrasting approach is a plurality of self-contained light emitting devices are spaced at intervals and affixed to the collar by a fastener.

Although devices of this kind provide concerned pet owners with an added margin of safety when used, their current configurations have several shortcomings. Light emitting elements that are bright enough to be useful tend to be large to allow room for adequate batteries. Those that are lighter and smaller are more likely to be obscured by fur and are either relatively dim or drain their power sources quickly. Additionally, the current designs are not suited to be worn in rainy weather or when a pet is swimming. As a result, current lighted collar designs are not adapted to be worn continuously or comfortably by the pets they are designed to protect. It is therefore likely that an owner will overlook or misplace the collar when it is needed.

Accordingly, there exists a need for an illumination device for pet collars and other pet accessories which can be illuminated in dark environments providing increased safety for the pet and its owner. Additionally, a need exists for an illumination device for pet collars and other pet accessories which has a weather resistant switch and light source for use in all types of environments. Furthermore, there exists a need for an illumination pet collars and other pet accessories which can actually replace the old pet collar and used everyday both in lighted and dark environments.

### SUMMARY

The present invention is an illumination device for collars and other accessories. The illumination device comprises a tubular strap. A lighting mechanism having a light source is at least partially receivable within the tubular strap. A mechanism activates the lighting source within the mechanism wherein light from the light source is emitted through at least a portion of the tubular strap.

In addition, the present invention includes a method for constructing an illuminated collar. The method comprises providing a tubular strap, forming a slit in the tubular strap, providing a lighting mechanism having a light source box connected to a polymer, inserting the lighting mechanism into the slit of the tubular strap, activating the lighting mechanism, and illuminating the collar through the tubular strap.

The present invention further includes an assembly for illuminating collars. The device comprises a strap device with the strap device being substantially tubular and having an opening, and lighting means for illuminating the strap device with the lighting means being at least partially receivable within the strap device through the opening.

### BRIEF DESCRIPTION OF THE DRAWINGS

FIG. 1 is an elevational side view illustrating an illuminated pet collar, constructed in accordance with the present invention;

FIG. 2 is a top plan view of a lighting mechanism of the illuminated pet collar, constructed in accordance with the present invention;

FIG. 3 is a sectional view taken at Section B in FIG. 1 illustrating a portion of the illuminated pet collar of FIG. 1, constructed in accordance with the present invention, with a slit formed therein for receiving the lighting mechanism;

FIG. 4 is a perspective view illustrating a first plate of a weather resistant light source box of the lighting mechanism, constructed in accordance with the present invention; and

FIG. 5 is a perspective view illustrating a second plate of a weather resistant light source box of the lighting mechanism, constructed in accordance with the present invention.

### DETAILED DESCRIPTION OF THE PREFERRED EMBODIMENTS

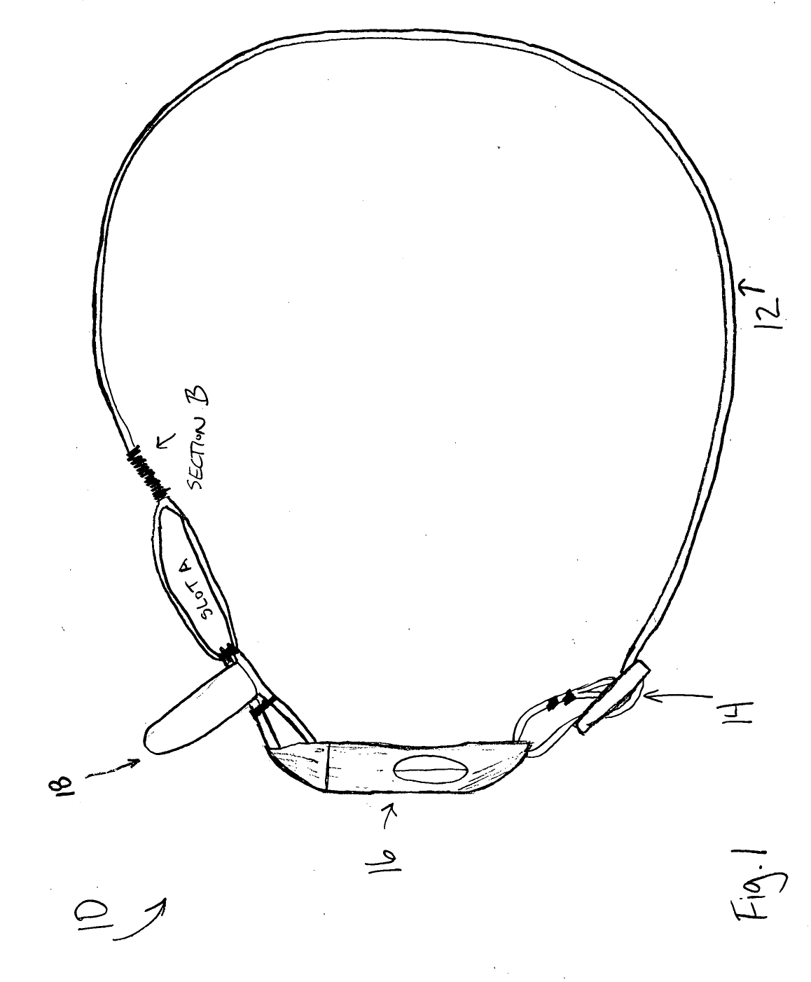

As illustrated in FIG. 1, the present invention is an illumination device, generally designated as 10, for pet collars 12 and other pet accessories. For illustration purposes, the illumination device 10 will be discussed as related to pet collars 12 but, as will be understood by those persons skilled in the art, can also be used for other goods other than pet collars 12 and pet accessories.

The pet collar 12 for use with the illumination device 10 of the present invention preferably has a tubular construction. Furthermore, the pet collar 12 can have an adjusting mechanism 14, a fastening mechanism 16, and a leash ring 18. In a preferred embodiment, the pet collar 12 is constructed from a nylon material. Constructing the pet collar 12, however, from other durable materials is within the scope of the present invention.

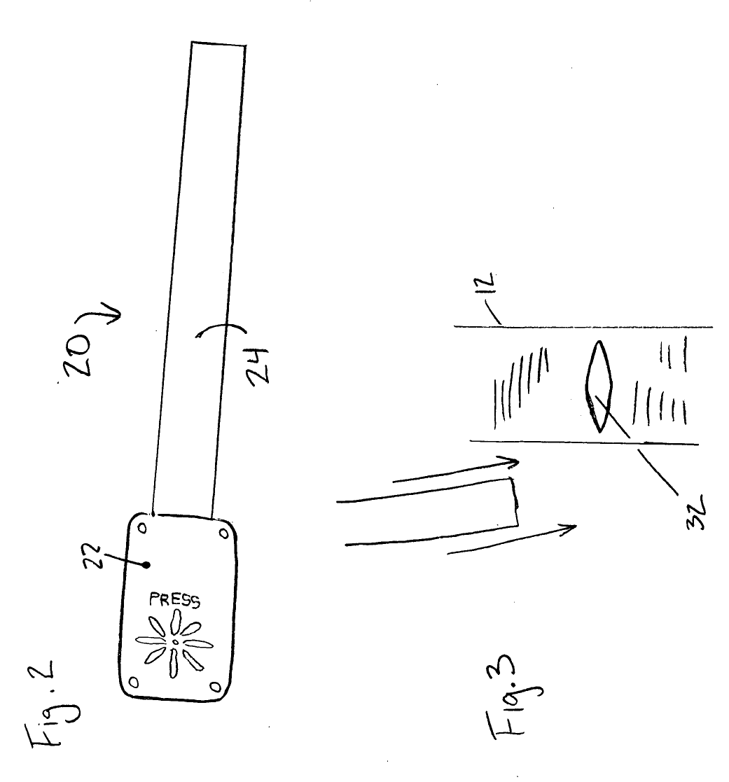

The pet collar 12 is illuminated by a lighting mechanism 20 inserted into the tubular pet collar 12. As illustrated in FIG. 2, the lighting mechanism 20 includes a light source box 22 and a polymer 24 connected to the light source box 22. The lighting mechanism 20 has a switch for selectively illuminating the lighting mechanism 20. In a preferred embodiment, the L.E.D. lighting mechanism 20 is attached to the polymer material which transmits light through the pet collar 12 in a highly visible manner although any type of lighting mechanism is within the scope of the present invention.

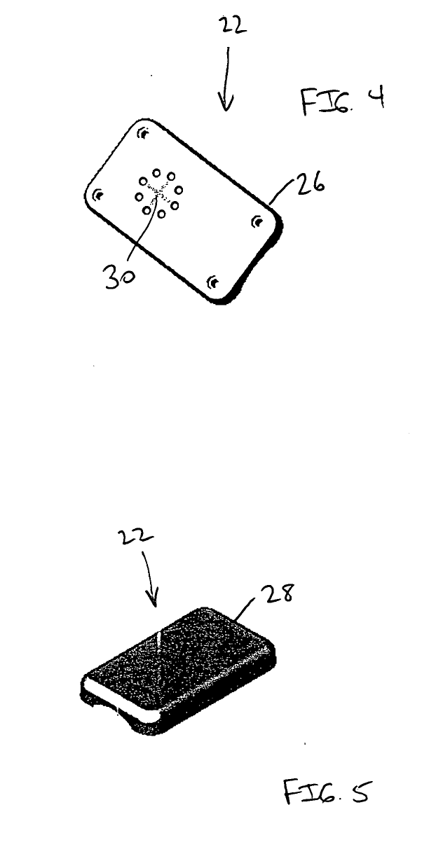

In addition, due to the active endeavors of pets, it is preferable that the lighting mechanism 20 is weather resistant to maintain water and other moisture from entering the light source box 22. An example of a weather resistant light source box 22 is illustrated in FIGS. 4 and 5 with the light source box having a first plate 26 and a second plate 28 which cover and protect the internal light activation components (not shown). Activation of the light source box 22 is accomplished by simply pressing the first and second plates 26, 28 at an activation site 30.

Preferably, the polymer 24 is constructed from a flexible polymer material although constructing the polymer 24 from another type of flexible material capable of carrying light is within the scope of the present invention.

The construction and operation of the illuminated pet collar 10 of the present invention will now be discussed. First, a slit 32 is formed in the tubular pet collar 12, as illustrated in FIG. 3. The polymer light source with polymer attached is then inserted into the slit 32 of the pet collar. Once the polymer 24 is completely inserted between the sewn nylon of the pet collar 12, the light source box 22 is then inserted into the slit. Friction maintains the light source box 22 and the polymer 24 within the pet collar 12. Now, the lighting mechanism 20 can be activated to illuminate the pet collar 12 for fun and safety of the pet.

The illuminated pet collar 10 of the present invention has many distinct features and advantages, including, but not limited to, the following:
a) Weather resistant switch and light source;
b) Comes in multiple colors;
c) Replaces old collar
d) Runs off a watch-type battery with two hundred (200) hours of on time;
e) Completely adjustable;
f) Can be seen up to one-half (½) mile;
g) Provides a safe environment while out at night;
h) Lighted leash for safety while walking or running at night;
i) Push button light activation;
j) Shock resistant;
k) Reusable; and
l) Ten thousand (10,000) hour LED life.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

1. An illumination device for collars and other accessories, the illumination device comprising:
a tubular strap;
a lighting mechanism having a light source at least partially receivable within the tubular strap; and
lighting means for activating the lighting source within the mechanism;
wherein light from the light source is emitted through at least a portion of the tubular strap.

2. The illumination device of claim 1 wherein the tubular strap includes an adjusting mechanism, a fastening mechanism, and a leash ring.

3. The illumination device of claim 1 wherein the tubular strap is constructed from a nylon material.

4. The illumination device of claim 1 wherein the lighting mechanism includes a light source box and a polymer connected to the light source box.

5. The illumination device of claim 4 wherein the polymer is constructed from a flexible polymer material.

6. The illumination device of claim 1 wherein the lighting mechanism has a switch for selectively illuminating the lighting mechanism.

7. The illumination device of claim 1 wherein the lighting mechanism is weather resistant.

8. The illumination device of claim 7 wherein the lighting mechanism includes a weather resistant light source box, the light source box having a first plate and a second plate which cover and protect internal light activation components wherein activation of the light source box is accomplished by pressing the first and second plates at an activation site.

9. The illumination device of claim 1 wherein the tubular strap can be a variety of colors.

10. The illumination device of claim 1 and further comprising:
an illuminated leash.

11. The illumination device of claim 1 and further comprising:
an illuminated harness.

12. A method for constructing an illuminated collar, the method comprising:
providing a tubular strap;
forming a slit in the tubular strap;
providing a lighting mechanism having a light source box connected to a polymer;
inserting the lighting mechanism into the slit of the tubular strap;
activating the lighting mechanism; and
illuminating the lighting mechanism through the tubular strap.

13. The method of claim 12 and further comprising:
adjusting the tubular strap to a desired length; and
fastening the adjustable strap to form a loop.

14. The method of claim 12 and further comprising:
constructing the lighting mechanism in a weather resistant fashion.

15. The method of claim 12 and further comprising:
constructing the light source box from a first plate and a second plate;
activating the light source box by pressing the first and second plates at an activation site.

16. The method of claim 12 and further comprising:
connecting an illuminated leash to the tubular strap.

17. An assembly for illuminating collars, the device comprising:
a strap device, the strap device being substantially tubular and having an opening; and
lighting means for illuminating the strap device, the lighting means being at least partially receivable within the strap device through the opening.

18. The assembly of claim 17 wherein the strap device includes an adjusting mechanism, a fastening mechanism, and a leash ring.

19. The assembly of claim 17 wherein the lighting means includes a light source box and a polymer connected to the light source box.

20. The assembly of claim 17 wherein the lighting means has a switch for selectively illuminating the lighting mechanism.
